(19) United States
(12) Patent Application Publication
(10) Pub. No.: US 2021/0396132 A1
(43) Pub. Date: Dec. 23, 2021

(54) A System and Method for Measuring a Signal Generated by a Wellbore Transmitter

(71) Applicant: GroundMetrics, Inc., San Diego, CA (US)

(72) Inventors: Mark S. DIIORIO, San Diego, CA (US); Joseph M. PENDLETON, Temecula, CA (US); Stacy J. KOUBA, San Diego, CA (US); Daniel LATHROP, San Diego, CA (US); Igor FRIDMAN, Rockville, MD (US)

(21) Appl. No.: 17/289,409

(22) PCT Filed: Dec. 13, 2019
(86) PCT No.: PCT/US2019/066335

§ 371 Date: Apr. 28, 2021

Related U.S. Application Data
(60) Provisional application No. 62/779,866, filed on Dec. 14, 2018.

(51) Int. Cl. E21B 47/13; G01V 3/38

(52) U.S. Cl. CPC E21B 47/13; G01V 2210/32; G01V 3/38

(57) ABSTRACT

Techniques to improve the measurement of electromagnetic fields based on noise cancellation are disclosed. Sensors placed at the earth's surface measure electromagnetic fields emanating from within the earth, and/or perform electromagnetic telemetry. In one embodiment, signal processing techniques are applied to the acquired signals, either in real time or near real time to reduce or cancel the noise to enable the signal of interest to be measured. In another embodiment, the location of the plurality of sensors is judiciously chosen to improve the measurement of the signal of interest.

### CROSS REFERENCE TO RELATED APPLICATION

This application claims the benefit of U.S. Provisional Application No. 62/779,866 filed on Dec. 14, 2018 and entitled, “Noise Cancellation for Measuring Electromagnetic Fields Within the Earth”. The entire contents of this application are incorporated herein by reference.

### FIELD OF THE INVENTION

This disclosure is related to the field of measurement of electromagnetic fields within the earth. More particularly, the disclosure relates to techniques to improve the ability of sensors placed at or near the earth's surface to measure electromagnetic fields emanating from within the earth by employing noise cancellation techniques. Noise cancellation can be used for a wide variety of applications, including but not limited to electromagnetic telemetry (“EMT”), geosteering, reservoir characterization and monitoring, and hydraulic fracturing. EMT is of particular interest and is used with measurement while drilling (“MWD”) and logging while drilling (“LWD”). The disclosure relates to techniques, methods, and systems to improve signal quality and/or reduce noise in the measured data, and/or improve the ability of MWD and/or LWD instruments to communicate with instruments at or near the earth's surface.

### BACKGROUND OF THE INVENTION

The field of measuring electromagnetic fields within the earth includes a wide array of applications, non-limiting examples of which are electromagnetic telemetry to communicate with downhole instruments, geosteering, electromagnetic surveys of the earth for locating and imaging oil and gas deposits, including enhanced oil recovery, and electromagnetic surveys for carbon dioxide storage. For example, U.S. Patent Application Publication 2017/0097441 A1, incorporated herein by reference, discloses a system and method for performing distant geophysical surveys by measuring the electromagnetic field emanating from the subsurface. The source of the electromagnetic field in these applications can be either natural or manmade.

Drilling operations widely employ MWD and LWD in order to maintain smooth operation of the equipment and provide decision support. The instrumentation data recorded during drilling is often vital in verifying drill direction in horizontal drilling, and often is the primary source of geophysical information about the formation. While data can be communicated to the surface using a mud pulse or other means, EMT is generally able to transmit real-time data from a wellbore transmitter to the surface at higher data rates compared to mud pulse and more cost effectively compared to other electromagnetic methods. U.S. Pat. No. 7,145,473, incorporated herein by reference, describes an example of electromagnetic telemetry for communicating signals between MWD and/or LWD instruments placed in a wellbore and equipment placed at the earth's surface (“uplink’). Various types of MWD/LWD instruments are known in the art, such as ones that emit primarily electric fields using a dipole antenna, or ones that emit primarily magnetic fields using wire coils. These instruments generate a time-varying electromagnetic field that propagates out to the earth's surface and is acquired by a plurality of sensors. Measurements of interest from the MWD/LWD instrument may be encoded into the time-varying electromagnetic field, and are subsequently decoded. On the other hand, transceivers or other signal sources at the earth's surface can generate a time-varying electromagnetic field that propagates down near the wellbore and is acquired by the MWD/LWD instruments (“downlink”). Similarly, information of interest from the earth's surface may be encoded into the time-varying electromagnetic field, and are subsequently decoded by the instruments in the wellbore. The EMT signals travel large distance in the earth and hence are generally small and hence readily obscured by large electromagnetic noise interference that is present during drilling operations. This noise often prevents the driller from obtaining the important MWD/LWD data in a timely fashion and hence it is desirable to remove or reduce this electromagnetic noise from the signal.

There have been several proposals set forth in the industry in an attempt to address this problem. For example, U.S. Pat. No. 6,781,520 teaches the use of adaptive filters to remove noise from a signal channel in a borehole telemetry system. However, the process requires additional motion sensors that detect noise and provide a noise reference channel free of telemetry signal content. U.S. Pat. No. 10,190,408 takes a different approach and employs numerous pairs of antennas each receiving a signal. The method in the '408 patent relies on using a complicated decoding step. WO 2018/174900 discloses method for active noise cancellation in electromagnetic telemetry. However, the method relies on employing single counter electrodes and a wellhead in combination to measure signals, as such the method suffers from the disadvantage of measuring very high noise generated near the wellhead by drilling equipment. Therefore, there exists a need in the art for a more effective way to measure a received signal containing a signal from a wellbore transmitter and noise and to separate the signal from the noise. There also exists a need to have the signal be measured in an efficient way without requiring the extra equipment or steps required by the prior art methods.

### SUMMARY OF THE INVENTION

One aspect of the disclosure relates to a method of improving the signal quality of the electromagnetic field acquired at or near the earth's surface emanating from the EMT transmitter within a MWD/LWD instrument by reducing electromagnetic noise interference. In this method, signal processing techniques, including but not limited to onboard/embedded digital signal processing circuitry, proprietary signal processing algorithms, etc., are applied to the acquired signals, either in real time, near real time (defined here as approximately less than one minute delay from real time), or during post-processing.

Another aspect of the disclosure relates to a method of configuring sensor modules at the earth's surface to improve the signal quality of the electric and/or magnetic field “electromagnetic field” acquired at or near the earth's surface. In this method, the location of and/or the configuration of each sensor module is judiciously chosen so as to reduce noise in the electromagnetic field and to obtain the desired signal.

More specifically, one preferred embodiment of the invention is directed to a system for measuring, at or near the surface of the earth, a telemetry signal generated by a wellbore transmitter in the presence of at least one interfering signal. The system includes a first sensor module including a first electronic circuit and first and second individual sensors, with at least one individual sensor connected to the first electronic circuit unit. The first sensor module is located at or near the surface of the earth. Also, the first sensor module is configured to measure a first signal encompassing both the telemetry signal generated by the wellbore transmitter and the at least one interfering signal. The system also includes a second sensor module including a second electronic circuit and third and fourth individual sensors, with at least one individual sensor connected to the second electronic circuit. The second sensor module is located at or near the surface of the earth and is configured to measure a second signal encompassing the telemetry signal and the at least one interfering signal. The system also includes a signal processing unit connected to the first and second sensor modules for executing signal processing techniques on the first and second signals to develop an estimate of the at least one interfering signal and to obtain the telemetry signal.

The invention is also directed to an associated method for measuring a telemetry signal generated by a wellbore transmitter. The method includes measuring, at or near the surface of the earth, a first signal encompassing both the telemetry signal generated by the wellbore transmitter and at least one interfering signal with a first sensor module including a first electronic circuit and first and second individual sensors, with at least one individual sensor connected to the first electronic circuit unit. Next the method includes measuring, at or near the surface of the earth, a second signal encompassing the telemetry signal and the at least one interfering signal with a second sensor module including a second electronic circuit and third and fourth individual sensors, with at least one individual sensor connected to the second electronic circuit. The method then executes signal processing techniques, with a signal processing unit on the first and second signals, and develops an estimate of the at least one interfering signal and obtains the telemetry signal.

In another preferred embodiment, a method is provided that includes measuring a first signal representing the desired signal and the interfering signal with a first individual sensor and a second individual sensor and then measuring a second signal representing the desired signal and the interfering signal with a third individual sensor and a fourth individual sensor or at least one of the first and second individual sensors. At least one of the individual sensors is a capacitive electrode connected to an electronic circuit. The method then includes executing signal processing techniques, with a signal processing unit on the first and second signals to develop an estimate of the at least one interfering signal and to obtain the telemetry signal.

The invention improves the ability of the wellbore instruments and sensors at the earth's surface to communicate with one another in an environment that typically has electromagnetic noise interference from sources such as active drilling operations, pumps, motors, heavy machinery, electric line voltages, generators, AC or DC electric drives or the like. Electromagnetic noise from drawworks motors, top drive motors, and mud pumps are particularly large during drilling operations. The EMT communication signals decrease in magnitude when they travel long distances through the earth and the small signal measured at the surface can often be obscured by much larger electromagnetic noise interference. The invention allows the equipment operator to detect smaller signals in highly resistive or highly conductive formations both unfavorable to EMT, to increase the transmit frequency to increase the data throughput rate, or to reduce the transmit power to save precious battery life. The overall benefit is to increase the amount of useful data exchanged between the wellbore instruments and sensors at the earth's surface thereby enabling the well to be drilled faster, more accurately and at lower cost.

The preceding summary is provided to facilitate an understanding of some of the innovative features unique to the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following description of various illustrative embodiments in connection with the accompanying drawings.

FIG. 1 shows an example of drilling, MWD, LWD, and telemetry systems according to a preferred embodiment of the invention.

FIG. 2 shows one preferred embodiment of adaptive noise cancellation for electromagnetic telemetry.

FIG. 3 shows one preferred embodiment of gradiometer type noise cancellation for electromagnetic telemetry.

FIG. 4 shows another preferred embodiment of gradiometer type noise cancellation for electromagnetic telemetry.

FIG. 5 shows another preferred embodiment of gradiometer type noise cancellation for electromagnetic telemetry.

FIG. 6 shows preferred embodiments of a sensor module comprising at least two individual sensors and an electronics circuit.

FIG. 7 shows another preferred embodiment of using sensor modules to measure signal and noise for noise cancellation for telemetry.

FIG. 8 shows a preferred embodiment of using sensor modules to measure signal and noise for noise cancellation for telemetry along with some wire cable connections from the sensor modules to a signal processing unit.

FIG. 9 shows a preferred embodiment of performing noise cancellation inside the signal processing unit.

FIGS. 10A-10C show sample frequency domain and time-series data acquired by two capacitive sensor modules on the surface where one sensor module receives much less electromagnetic noise compared to the other.

FIG. 11 Shows data from one capacitive sensor module before and after applying adaptive noise cancellation with a second sensor module for EMT signals on a drilling rig.

### DETAILED DESCRIPTION

The following detailed description should be read with reference to the drawings in which similar elements in different drawings are numbered the same. The detailed description and the drawings, which are not necessarily to scale, depict illustrative embodiments and are not intended to limit the scope of the disclosure. The illustrative embodiments depicted are intended only as exemplary. Selected features of any illustrative embodiment may be incorporated into an additional embodiment unless clearly stated to the contrary. While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

As used in this specification and the appended claims, the singular forms “a”, “an” and “the” include plural referents unless the content clearly dictates otherwise. As used in this specification and the appended claims, the term “or” is generally employed in its sense including “and/or” unless the content clearly dictates otherwise.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range.

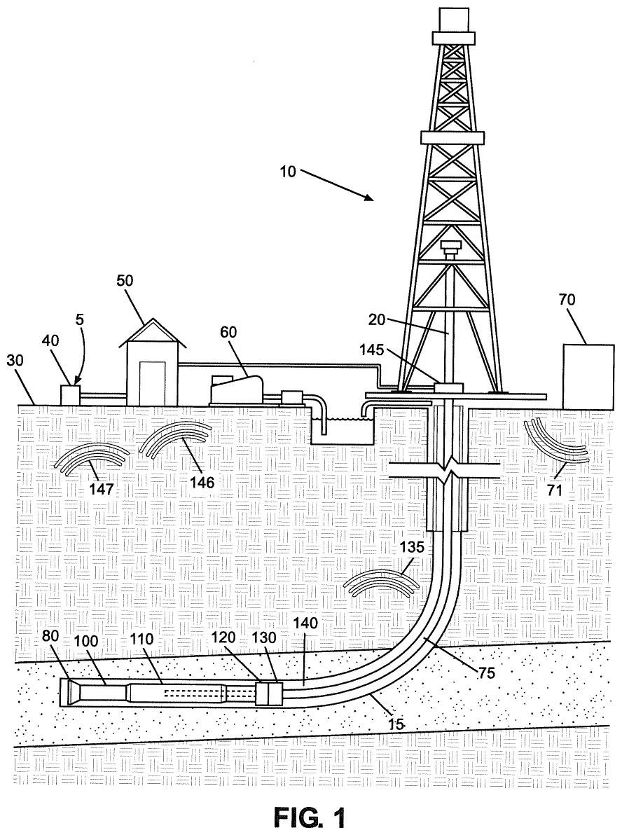

FIG. 1 is shown for reference to introduce an example of the overall configuration of the wellbore, sensors, noise sources, and other equipment cited in this disclosure for some of the applications including electromagnetic telemetry. The drilling rig 10 is performing a horizontal drill operation to form a wellbore 15 with a drill pipe 20 into the earth 30 at the blowout preventer (BOP) 145. Near the drill rig are a MWD work trailer 50 for viewing the telemetry information, mud pumps 60 and electrical generators 70. The electrical generators 70 and mud pumps are common sources of electromagnetic noise as represented by at least one interfering signal 71. The drill pipe 20 extends down vertically and turns horizontally at a bend 75. In many drilling operations, it is important to drill horizontally in the lateral 140. At the end of the drill pipe 20 is the drill bit 80, preceded by a mud motor 100, a MWD and/or LWD tool 110, a transmitter 120 and a gap sub 130. For the purposes of this description, the tool 110 and wellbore transmitter 120 form the MWD/LWD instrument. The MWD/LWD instrument transmits information by emitting an electromagnetic telemetry signal 135 generated by wellbore transmitter 120. This information is very useful in order to steer the drill, especially in the curve (bend) and lateral 140. At the surface, the electromagnetic signals including a first signal 146 and a second signal 147 are acquired by a sensor arrangement 40. The sensor arrangement 40 preferably contains sensor modules or a plurality of individual sensors as shown and discussed in more detail below. First signal 146 preferably encompasses both the telemetry signal 135 and at least one interfering signal 71. Second signal 147 preferably encompasses the at least one interfering signal 71 and preferably also encompasses the telemetry signal 135, but not in the same strengths as the first signal 146. The electromagnetic signal, for example the first signal 146, is often measured as a voltage, which requires a measurement at two different points at or near the surface of the earth, often using two individual sensors. The measured voltage signal is the difference in the electric field at each measurement location multiplied by the separation between the individual sensors. A larger separation between the individual sensors can lead to the measurement of a larger electromagnetic signal, including the telemetry signal of interest 135 and/or undesirable noise interference signals represented by at least one signal 71. For some types of sensors that measure voltage, including galvanic electrode sensors and capacitive electrode-based sensors, the electromagnetic signal is measured between two individual sensors of the same type or between two different types of individual sensors.

MWD and LWD instruments 110 in the wellbore 15 are typically used to measure a set of properties of the earth 30 in contact with or in proximity to the drill string. The instruments 110 have the ability to measure, process, and/or store information. These instruments 110 measure properties such as, but not limited to, electrical properties, magnetic properties, gamma ray, nuclear magnetic resonance, optical properties, acoustic properties, radiological properties, mechanical properties, or the like. These non-limiting examples account for the various properties and information which may aid in probing the earth 30, identifying the content of the material, guiding the drill path or otherwise providing useful information to the operator of the apparatus.

Wellbore instruments 110 communicate with sensors at the earth's surface. MWD/LWD instruments in the wellbore 15 may typically be configured to send data to the surface by encoding it onto a time-varying electromagnetic field such as telemetry signal 135. Specifically, the data may be encoded into the amplitude, phase and/or frequency of any spatial component of either the electric or magnetic field. Examples of encoding include, but are not limited to Quadrature Phase Shift Keying (QPSK), Quadrature Amplitude Modulation (QAM), Binary Phase Shift Keying (BPSK), Differential Phase Shift Keying (DPSK) and Frequency Shift Keying (FSK).

Sensors, in sensor arrangement 40, placed at or near the earth's surface have the ability to measure electromagnetic field at frequencies of interest, which span a range of frequencies from 0 to at most 1 kHz. In certain embodiments, the lowest frequency is at least 0.01 Hz and at most 1 kHz. Non-limiting examples of sensors are capacitive electrode-based sensors, galvanic electrode sensors, magnetic sensors, and hybrid sensors.

Conventional galvanic electrode sensors can be used to connect to the earth to measure electric potential. These galvanic electrodes typically consist of metal rods driven into the earth. They could also use a metal/metal salt interface which is in direct contact to the earth. These electrodes rely on the flow of electrical current across the interface to measure the local electric potential. The contact between the electrode and the earth is primarily resistive and this contact resistance needs to be sufficiently low for practical applications where the resistance is below 5 kΩ and more preferably below 1 kΩ. For convenience, this entire class of conventional electrodes is termed “galvanic electrodes” and comprises an example of an individual sensor.

Capacitive electrode-based sensors can either be a capacitive electrode alone or a capacitive electrode attached to an electronic circuit (also termed a “capacitive sensor”). The capacitive electrode is an individual sensor that measures the electric potential at one point at or near the surface of the earth by virtue of operative capacitive coupling between the earth and a sensing plate. The sensing plate includes a barrier which provides electrochemical segregation between the sensing plate and the earth. A capacitive electrode attached to an electronic circuit adds, for example, as an amplifier having at least one stage for receiving and amplifying a signal carrying the potential measured by the sensing plate. Capacitive sensors were disclosed in U.S. Pat. No. 9,405,032 B2 by Hibbs, incorporated herein by reference. As disclosed by Hibbs, the electrochemical segregation provided by the barrier is defined by a resistance larger than 10 kΩ between the sensing plate and the earth.

Non-limiting examples of magnetic sensors are induction-type sensors, fluxgate magnetometer sensors, or the like. Such non-limiting examples were disclosed in U.S. Pat. No. 7,141,968 B2 by Hibbs at al. and U.S. Pat. No. 7,391,210 B2 by Zhang et al, each incorporated herein by reference. The particular architecture and method of action of the magnetic sensors is not pertinent to this application. The common features of the sensors are that they measure the magnetic field of the earth or of the surrounding area between frequencies of 0 Hz and 10 kHz and are placed at the earth's surface.

There are a wide variety of noise sources on the drill rig 10 that can interfere with EM telemetry signals 135. Because EM telemetry operates at relatively low frequencies, below 200 Hz, sources of electromagnetic noise, such as the interfering signal 71, at these frequencies are of the greatest concern. Major sources of EM noise typically include top drive and drawworks motors that move the drill string, mud motors that circulate drilling mud down to the drill bit 80, and electrical generators that power the drill rig 10. The noise that is generated when a large motor is turned on or off can often impact the signal 135. Other noise sources can include vibration of electrical conductors from the drilling operations and improper or suboptimal electrical grounding of the drill rig 10.

The EMT signal 135 generated by the transmitter 120 in the BHA is generally strongest at the surface for sensors located closer to the wellbore 15. Due to the metal in the drill string and higher up in the casing, the EM signal 135 travels in proximity to these conductors as opposed to traveling through the much more resistive formation. This has been shown to hold true by Jannin et al even for deviated wells where the EM signal is generated 5,000 feet out along the lateral. See “Deep electrode: A game-changing technology for electromagnetic (EM) telemetry” Gaelle Jannin, Juiping Chen, Luis Eduardo DePavia, Liang Sun and Michael Schwartz, SEG Technical Program Expanded Abstracts, 1059-1063, 2017. Jannin et al also indicates that the EMT signal value near the surface will be smaller at larger radial distances away from the wellbore 15 and that this signal is generally symmetric in magnitude at the same radial distance from the wellbore 15 for positions all around the wellbore 15.

Using a plurality of sensors in sensor arrangement 40 to measure or acquire the combination of LWD signals and/or MWD signals 135, in the presence of interfering signals 71, enables various data signal processing methods to separate the desired telemetry signals 135 from the electromagnetic noise interfering signals 71. Each individual sensor in the sensor modules or plurality of sensors in sensor arrangement 40 will receive different amounts of the desired signal 135 and the interfering signals 71, dependent on the location of the individual sensors in relation to the source of the various signals (desired telemetry signal 135 and interfering noise signals 71). The desired signal as received by any one of the sensor modules will be correlated with the desired signal as received by any of the other sensor modules. Likewise, any signal from an interfering source as received by any one of the sensor modules will be correlated with the signal from that same interfering source as received by any of the other sensor modules. In general, the desired signal will not be well correlated with any of the interfering signals. Well known signal processing methods can be used to remove the noise, including Adaptive Noise Cancellation. Related data processing methods, such as Principal Component Analysis (PCA), Independent Component Analysis (ICA) and Singular Value Decomposition (SVD), can be used to separate the desired signal from the interfering signal by separating signals from a plurality of sensors into a mutually uncorrelated set of signals. The sensitivity of each sensor module to the desired signal and to each of the interfering signals can be measured.

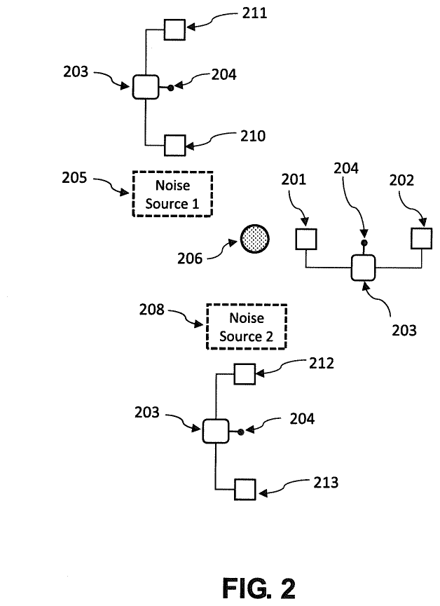

Data signal processing methods based on the correlation of signals detected by a plurality of individual sensors can also be used in real-time, near real-time, or post processing. An example of a sensor arrangement 40 of a plurality of individual sensors that can be used with this approach is shown in FIG. 2. Individual sensors 201 and 202 are placed near the wellhead 206 which is at the top of wellbore 15, while individual sensors 210 and 211 are placed near the first interfering source 205, which could, for example, be drawworks motors, and individual sensors 212 and 213 are placed near the second interfering source 208, which could be generators 70. With this arrangement, the interfering signal, which could be, for example, interfering signal 71, from the first interfering source 205 will be received most strongly by individual sensors 210 and 211, the interfering signal from the second interfering source 208 will be received most strongly by individual sensors 212 and 213, and the desired signal, which could, for example be desired telemetry signal 135, will be received most strongly by individual sensors 201 and 202. By signal processing the correlation between the signal, which could, for example be signal 146, received by individual sensors 210 and 211 and the signal, which could, for example be signal 147, received by individual sensors 201 and 202, the amount of the first interfering signal received by individual sensors 201 and 202 can be estimated and removed or reduced from the signal measured by individual sensors 201 and 202. Similarly, the amount of the second interfering signal can be estimated and removed or reduced by processing the correlation between the signal received by individual sensors 212 and 213 and the signal received by individual sensors 201 and 202. This results in a reduction of the interfering signals in the processed data from individual sensors 201 and 202, while the amount of the desired signal is not reduced or only minimally reduced. Measuring the desired signal 135 and the interfering signal 71 with each sensor module in a plurality of individual sensors can be used with Adaptive Noise Cancellation, Principle Component Analysis, Independent Component Analysis, Singular Value Decomposition or a similar method to perform noise cancellation based on the correlations between the signals (146, 147) acquired by the plurality of sensor modules. The selected method of measuring the correlations can then be used to separate the desired signal from the interfering signals in real time or near real time to reduce or remove the interfering noise that will change with environmental conditions, with the configuration of the drill rig, and as the drilling advances. This example uses a pair of individual sensors encompassing either capacitive electrodes or galvanic electrodes since each type needs to measure a voltage difference between two points on the earth. The use of two individual sensors to measure the signal and noise interference is a non-limiting example and more than two individual sensors can be beneficially used to measure the signal and/or noise interference.

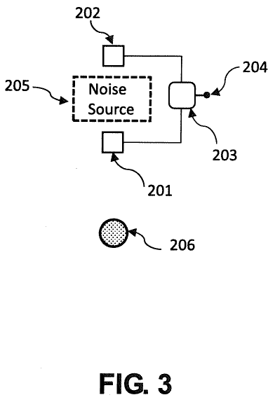

Another approach to reducing the noise is configuring a plurality of individual sensors in fixed locations where the noise cancellation stems from the geometric arrangement of the sensors with respect to the signal and noise sources. This is sometimes referred to as a gradiometer arrangement for two individual sensors located as shown in FIG. 3. The output from individual sensor 201 and individual sensor 202 are fed into an electronic circuit such as data acquisition system 203. In one embodiment the electronic circuit is able to acquire the data and output a difference in the voltage from each individual sensor. If individual sensor 201 and individual sensor 202 are located such that they both receive a similar magnitude of noise from a noise source 205, most or much of the noise from noise source 205 is cancelled or reduced. Generally, the desired telemetry signal 135 will be strongest closer to the wellhead 206 being drilled. Since the individual sensor 201 is located closer to wellhead 206 in this example, individual sensor 201 can receive a higher signal than individual sensor 202 that is located further away. Thus, the difference of the signals measured by each individual sensor 201 and 202 out of the data acquisition system 203 can still be a significant fraction of the total signal measured at individual sensor 201, while the interfering noise has been reduced or cancelled. A galvanic electrode 204 can be used on the data acquisition system 203 to provide another individual sensor (ground reference to the earth below) for the measured voltages from each of the other individual sensors connected to 203. In other embodiments this galvanic electrode could be a nearby metal fence or post. While connection to the wellhead 206 is also possible, it generally much less desirable since contains much noise from the drilling rig 10.

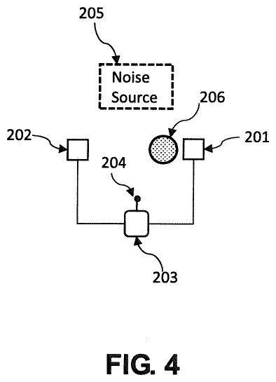

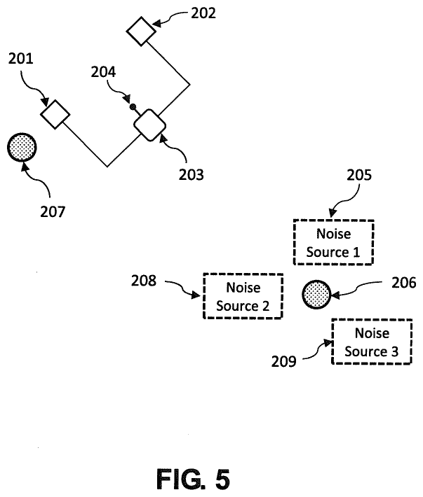

An alternative arrangement for the gradiometer method is shown in FIG. 4. Again, as described above, individual sensor 201 is positioned closer to the strongest telemetry signal compared to the individual sensor 202, while both individual sensors detect similar noise from the noise source 205 in order to provide noise cancellation or reduction. Another alternative arrangement for the gradiometer is shown in FIG. 5. Here, a second wellhead 207 acts an antenna and enhances the desired signal compared to what would otherwise be measured at this location. The gradiometer is oriented so that individual sensor 201 is located closer to the strongest desired signal source location nearer 207 compared to individual sensor 202. Both individual sensors are located at a distance from a single noise source or a plurality of noise sources 205, 208, and 209. Individual sensors 201 and 202 are oriented so that each detects a similar noise voltage, a process that is made easier by the distance from the noise sources. In addition, any noise picked up on the main wellhead 206 is cancelled by this orientation. It is generally understood by experts in the field that these are just examples and there are many gradiometer orientations that would provide noise cancellation. While two individual sensors are shown in the figures, it will be appreciated that a plurality of individual sensors can be used. The invention is not limited to one type of specific sensor. Examples of sensors include capacitive electrode-based sensors, galvanic electrodes, and magnetic sensors. In various situations, different types of sensors could be deployed within a gradiometer arrangement. For example, individual sensor 201 could be a capacitive electrode and individual sensor 202 could be a galvanic electrode sensor or a magnetic sensor. Many other combinations are possible. While horizontal arrangements are shown, it will also be appreciated that some noise cancellation could be performed with sensors located vertically, with one some distance above the other.

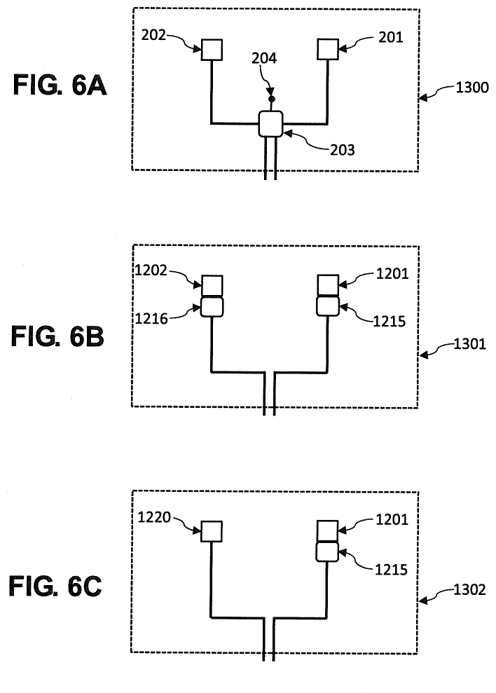

FIG. 6A shows one embodiment of a sensor module 1300 that includes the first individual sensor 201 and the second individual sensor 202, with the individual sensors connected to an electronic circuit such as data acquisition system 203. The output of the sensor module 1300 is a voltage difference and the sensor module 1300 can be used to measure the desired signal and/or interfering signals. Optionally, another individual sensor such as galvanic electrode 204 can be connected the data acquisition system 203 to enable the voltage difference from other combinations of individuals sensors to be measured, such as 201 and 204, and 202 and 204.

FIG. 6B shows another embodiment of a sensor module 1301 that includes a first individual sensor 1201 and a second individual sensor 1202, with the first individual sensor 1201 connected to a first electronic circuit 1215 and the second individual sensor 1202 connected to a second electronic circuit 1216. The first and second electronic circuits 1215 and 1216 can perform one or more stages of amplification, filtering, and/or signal conditioning. One example of this embodiment is using capacitive electrodes for both individual sensor 1201 and individual sensor 1202. Locating the electronic circuit 1215 very close to a capacitive electrode, for example, is beneficial since it can increase the sensitivity of the capacitive sensor (capacitive electrode and electronic processing unit) and send an improved signal to the signal processing unit. In telemetry applications there is often a long distance that the measured signal needs to travel through wires to the signal processing unit and very small signals can be degraded during this process.

FIG. 6C shows yet another embodiment of a sensor module 1302 that includes the first individual sensor 1201 and a second individual sensor 1220, with the first individual sensor 1201 connected to a first electronic circuit 1215. One example of this embodiment is using a capacitive electrode for individual sensor 1201 and a galvanic electrode for individual sensor 1220. Only one electronic circuit 1215 is used in this example since there are situations where only the capacitive electrode benefits from connecting to an electronic circuit. It will be appreciated that different combinations of sensor modules (1300, 1301, 1302) can be used to acquire signals. In other embodiments, sensor modules can contain three or more individual sensors and a plurality of electronic circuit units as beneficial.

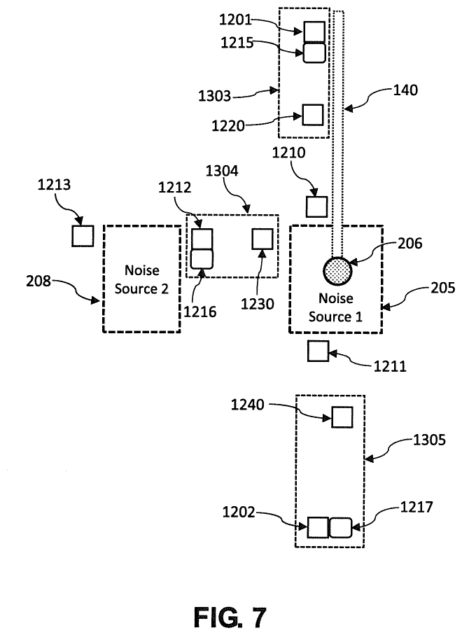

Other embodiments that take advantage of using a plurality of sensor modules configured for improved noise cancellation are shown in FIG. 7. In one example, a first sensor module 1303 includes individual sensor 1201 and individual sensor 1220 to measures a voltage difference between 1201 and 1220. In one embodiment, individual sensor 1201 could be a capacitive electrode connected to electronic circuit 1215 and individual sensor 1220 could be a galvanic electrode. This first sensor module 1303 could generally measure both the desired signal and interfering signal. A second sensor module 1304 could be added that includes individual sensor 1212 and individual sensor 1230 to measures a voltage difference between 1212 and 1230. In one embodiment, individual sensor 1212 could be a capacitive electrode connected to electronic circuit 1216 and individual sensor 1230 could be a galvanic electrode. This second sensor module 1304 could also measure both the desired signal and interfering signal, but because it is closer to some noise sources it might measure higher interfering signal. Sensor module 1303 and sensor module 1304 could be used as the two input channels to an adaptive noise cancellation method located within a signal processing unit. It will be appreciated that three or more sensor modules can be used. In another example, a third sensor module 1305 is added that includes individual sensor 1202 with electronic circuit 1217 and individual sensor 1240 to measures a voltage difference between 1202 and 1240.

Another embodiment shown in FIG. 7 uses individual sensor 1210 and individual sensor 1220 where the close proximity of sensor 1210 to noise source 205 can be beneficial for some noise cancellation methods including adaptive noise cancellation. Individual sensor 1212 and individual sensor 1220 would detect a larger interfering signal from noise source 208 compared to some other combinations of individual sensors. Individual sensor 1201 could be used with the individual sensor 1220 to measure a signal that contains less interfering signal since 1201 is further from both noise source 205 and noise source 208. In this example the four individual sensors 1201, 1210, 1212 and 1220 all lie in the same upper left quadrant in FIG. 7. More specifically, individual sensors 1201, 1210, 1212 and 1220 are located on the same side of the wellbore within an angle of 90 degrees from each other as measured in the plane of the surface of the earth with respect to the wellbore. In another example, individual sensor 1212 could be used with individual sensor 1220 to predominately measure the noise interference from the second interfering source 208. Due to the large noise interference, generally individual sensor 1210 and individual sensor 1212 will pick up noise from both first noise interfering source 205 and second noise interfering source 208. These individual sensors can beneficially consist of a combination of capacitive electrode-based sensors and galvanic electrodes.

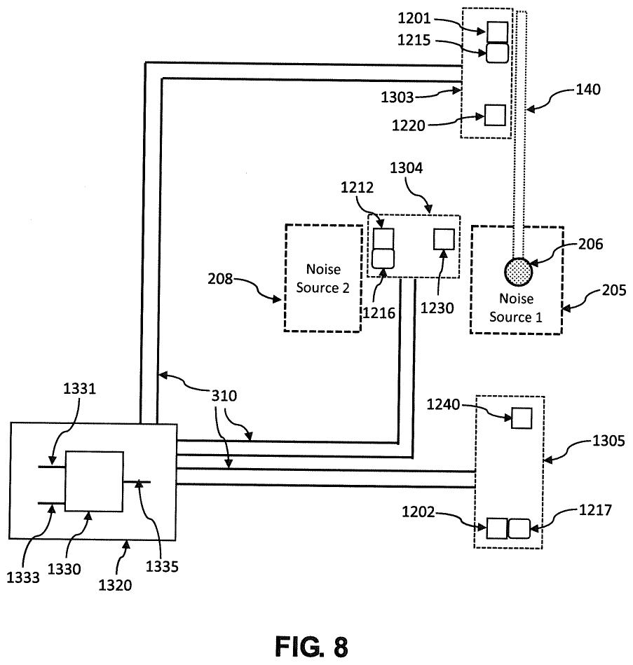

FIG. 8 shows and embodiment of how the three sensor modules (1303, 1304, 1305) shown in FIG. 7, and being part of the sensor arrangement 40 shown in FIG. 1, can be connected with wires (cables) 1310 to a signal processing unit 1320, often conveniently located in the trailer 50 also shown in FIG. 1. There are many examples of noise cancellation methods that will work with the sensor modules in FIG. 8. These include adaptive noise cancellation, PCA, ICA, and SVD. These noise cancellation methods can be used alone or in combination with one another. In one embodiment, shown in FIG. 8, an adaptive noise cancellation method 1330 is employed inside the signal processing unit 1320. Adaptive noise cancellation typically has two input channels 1331 and 1333 obtained from the sensor modules and one noise cancelled output 1335. The primary or “signal” channel input 1331 is preferably signal 146 and has the desired telemetry signal 135 and interfering noise signal 71. The “noise” reference channel input 1333 generally has a lower amount of desired signal versus interfering noise compared to signal channel input 1331. The noise reference channel input 1333 can have high interfering noise by locating the sensor module that provides the input nearer to interfering noise sources, such as 205 and 208. The noise reference channel input 1333 can also have small or unmeasurably small amounts of desired signal 135. The adaptive noise cancellation approach obtains an estimate of the interfering noise from the noise reference channel 1333 and uses it to reduce or remove interfering noise from the signal channel input 1331. The output 1335 can have reduced interfering signal 71, enabling the desired telemetry signal 135 to be obtained. It will be appreciated that the signal processing unit 1320 can employ methods to determine the best signal channel input and the best noise channel input from a plurality of sensor modules. In addition, the best signal channel input and the best noise reference channel input from a plurality of sensor modules of each can change with interfering noise sources turning on and off as well as with changing telemetry signal transmission including due to formation, transmitter power, transmitter frequency as non-limiting examples.

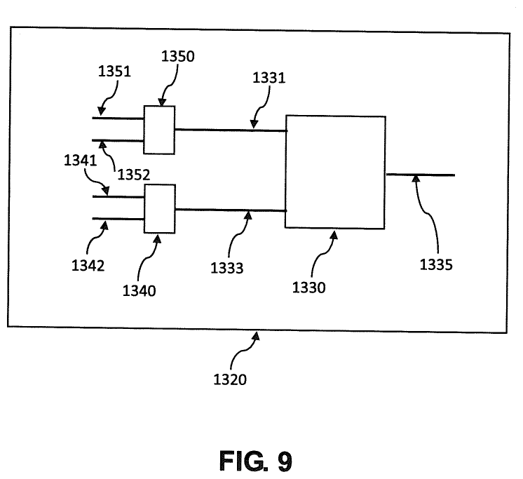

FIG. 9 shows other embodiments of how sensor modules can be combined for improved noise cancellation. In one example, two noise reference channel inputs 1341 and 1342 can be combined to produce a third, synthetic noise reference channel 1340, which is in turn used as the noise reference channel input 1333 to an adaptive noise cancellation method 1330. The noise reference channel input 1341 could come from a first sensor module located nearest to noise source 205 and the noise reference channel input 1342 from a second sensor module located nearest to a different noise source 208. In some situations, it may be advantageous to use two sensor modules, with each one located on opposite sides of the BOP (gradiometer arrangement) and then to combine the noise reference channels in a mathematical way so that the desired signal is nearly cancelled in the synthetic noise reference channel. In this way, the adaptive noise cancellation method can better focus on cancelling the interfering noise and to limit or avoid the unintended consequence of cancelling the desired signal. One method of combining noise reference channels is to subtract them, while in other methods they can be added together or combined in many different mathematical ways. For another example, referring to FIG. 7, a first sensor module could be created from individual sensor 1210 and individual sensor 1220, producing a first noise reference channel. A second sensor module could be created from individual sensor 1211, on the opposite side of the BOP, and individual sensor 1240, producing a second noise reference channel. By subtracting signal measured by the first sensor module (first noise reference channel input) from the second sensor module (second noise reference channel input), a new, synthetic noise reference channel input can be created with approximately double the interfering signal from noise source 205 and much reduced desired signal.

In another embodiment shown in FIG. 9, two signal channels inputs 1351 and 1352 can be combined to produce a third, synthetic signal channel 1350, which is in turn used as the signal channel input 331 to an adaptive noise cancellation method 330. The addition of two signal channel inputs with the correct polarity with respect to the direction of the signal can increase (up to double) the desired signal in the signal channel input to the adaptive noise cancellation signal processing. For example, referring to FIG. 7, a first sensor module could be created from individual sensor 1201 and individual sensor 1220, producing a first signal channel. A second sensor module could be created from individual sensor 1202, on the opposite side of the BOP, and individual sensor 1240, producing a second signal channel.

Both embodiments shown on FIG. 9 can also be combined where both a synthetic signal channel and a synthetic noise reference channel are created at the same time and used as respective inputs for the adaptive noise cancellation method and other correlation-based signal processing methods. It will be appreciated that more than two noise reference channels can be combined to produce a new synthetic noise reference channel and more than two signal channels can be combined to produce a new synthetic signal channel.

As another example, these signal processing techniques here, including adaptive noise cancellation can be combined with well-known filtering methods, such as bandpass filtering. As one specific example, bandpass filter can be used on the signal channel input and noise channel input prior to adaptive noise cancellation. This can improve the adaptive noise cancellation by reducing the amount of noise interference that lies outside the signal frequency band of interest (near the transmitter frequency), allowing the adaptive noise cancellation to focus on reducing the interfering signals that most impact the desired signal. Additional signal processing methods can be used with adaptive noise cancellation to help reduce or limit cancellation of the signal of interest. Adaptive noise cancellation, as well as other correlation-based signal processing methods can be used in combination with deploying sensors in a geometrically useful fashion such as in a gradiometer arrangement as also shown in FIG. 7. As an example, individual sensors 1212 and 1213 are arranged on opposite sides of the second interfering noise source 208 so that measuring the voltage between sensors 1212 and 1213 will produce a signal output with reduced noise from the second interfering noise source. This signal can be sent into the signal channel input 1331 for adaptive noise cancellation. Individual sensor 1210 and individual sensor 1220, will measure noise from the first interfering noise source 205 this voltage between 1210 and 1220 can be sent into the noise reference channel input 1333 for adaptive noise cancellation. Combining the gradiometer arrangement with adaptive noise cancellation can reduce or cancel the noise from multiple noise sources and/or provide improved noise cancellation from one noise source.

A preferred embodiment includes measuring, at or near the surface of the earth, a third signal encompassing the telemetry signal and the at least one interfering signal with a third sensor module including a third electronic circuit and fifth and sixth individual sensors, with at least one individual sensor connected to the third electronic circuit. In addition, the method includes determining the estimate of the at least one interfering signal at the first sensor module and using the estimate to reduce the at least one interfering signal from the first signal to obtain the telemetry signal.

In operation, and in accordance with a preferred embodiment of the invention, the method includes one of the sensor modules measuring the at least one interfering signal enabling this sensor module to be used as a noise reference channel to execute adaptive noise cancellation based on the noise reference channel. Alternatively, the adaptive noise cancellation may use outputs of at least two noise reference channels combined to produce a synthetic noise reference channel for the adaptive noise cancellation along with a third sensor module used as a signal channel input for the adaptive noise cancellation. Further, the adaptive noise cancellation may use the outputs of the at least two noise reference channels added or subtracted together to produce a synthetic noise reference channel having a reduced amount of the telemetry signal. Alternatively, or in addition, the outputs of at least two of the sensor modules, may be combined to produce a synthetic signal channel employed as a signal channel input for the adaptive noise cancellation.

In operation, and in accordance with another preferred embodiment of the invention, the method for measuring a desired signal generated by a wellbore transmitter includes measuring a first signal representing the desired signal and the interfering signal with a first individual sensor and a second individual sensor while measuring a second signal representing the desired signal and the interfering signal with a third individual sensor and either a fourth individual sensor or at least one of the first and second individual sensors. The method then includes executing signal processing techniques on the first and second signals with a signal processing unit to develop an estimate of the at least one interfering signal and to obtain the telemetry signal.

The signal processing techniques include calculating a mutually uncorrelated set of signals to determine the estimated interfering signal from the mutually uncorrelated set of signals. The signal processing techniques include determining an estimated sensitivity of each sensor module to the telemetry signal and to the at least one interfering signal based on the mutually uncorrelated set of signals and determining the estimate of the at least one interfering signal based on the estimated sensitivity. The signal processing techniques further include updating the estimated sensitivity over time. The signal processing techniques include one or more of principal component analysis, independent component analysis, single value decomposition, or adaptive noise cancellation, either used alone or in combination with one or more of the others. The signal processing techniques include convolutional neural networks, machine learning or artificial intelligence. An electromagnetic field signal of interest is measured to aid in geosteering the drill.

In another preferred embodiment of the invention a method is provided that includes measuring a first signal representing the desired signal and the at least one interfering signal with a first individual sensor and a second individual sensor. The method further includes measuring a second signal representing the desired signal and the at least one interfering signal with a third individual sensor and either a fourth individual sensor or at least one of the first and second individual sensors. At least one of the individual sensors is a capacitive electrode connected to an electronic circuit. The method further includes executing signal processing techniques on the first and second signals with a signal processing unit to develop an estimate of the at least one interfering signal and to obtain the telemetry signal

Yet another preferred method includes measuring a first signal representing the desired signal and the at least one interfering signal with a first individual sensor and a second individual sensor and measuring a second signal representing the desired signal and the at least one interfering signal with a third individual sensor and either a fourth individual sensor or at least one of the first and second individual sensors. At least one of the individual sensors is a capacitive electrode connected to an electronic circuit. The method further includes executing signal processing techniques on the first and second signals with a signal processing unit to develop an estimate of the at least one interfering signal and to obtain the telemetry signal. Preferably at least two of the individual sensors are configured in a gradiometer arrangement and the signal processing techniques include adaptive noise cancellation and/or principal component analysis, independent component analysis or singular value decomposition. Also, the signal processing techniques include adaptive noise cancellation and principal component analysis, independent component analysis or singular value decomposition. At least one individual sensor configured to measure the telemetry signal and at least one additional individual sensor configured to measure interfering noise are located on the same side of the wellbore as the lateral and within an angle of 90 degrees from each other as measured in the plane of the surface of the earth with respect to the wellbore.

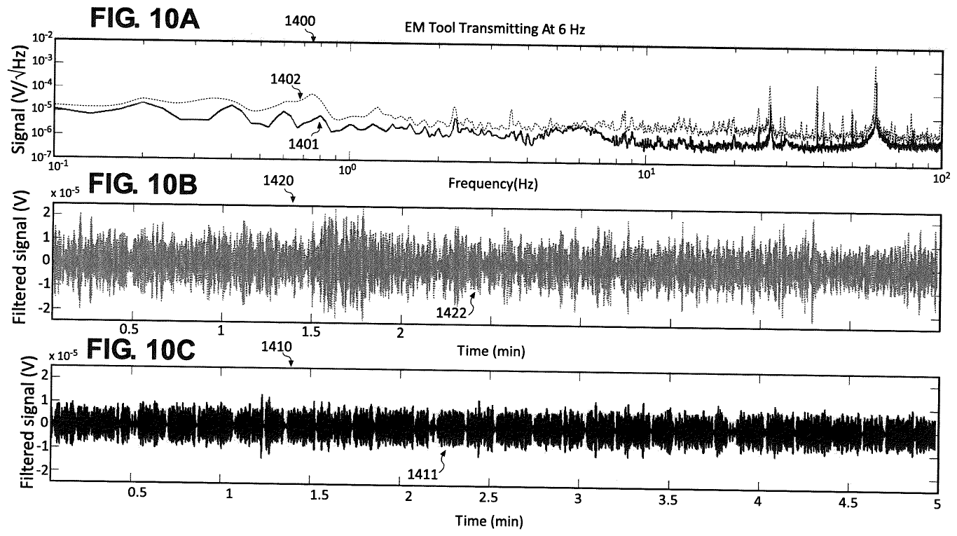

FIGS. 10A-10C show an example of time-series data acquired by two sensor modules using capacitive electrode-based sensors on the surface next to a drill rig during operations when encoded electromagnetic telemetry signals are being transmitted at near 6 Hz. The sensors are located such that one sensor receives much less electromagnetic noise compared to the other. While the data here are acquired in the time domain, this data can readily be displayed in the frequency domain using standard methods. FIG. 10A shows the frequency domain spectra 1400 for both sensors and shows that sensor 1 (1401) receives less noise interference compared to sensor 2 (1402). The transmitter signal near 6 Hz can be seen in the sensor 1 spectrum 1401 (a broader peak from approximately 5 to 7 Hz due to the encoding) but not in the sensor 2 spectrum 1402. FIG. 10B shows the time domain data 1420 for sensor 2 and the filtered time domain signal 1422 also for sensor 2 and the noise is large enough to prevent observation of the desired signal. FIG. 10C shows the time domain data 1410 for sensor 1 and the filtered time domain signal 1411 also for sensor 1 and the transmitter signals can readily be identified, including the on and off transmission periods.

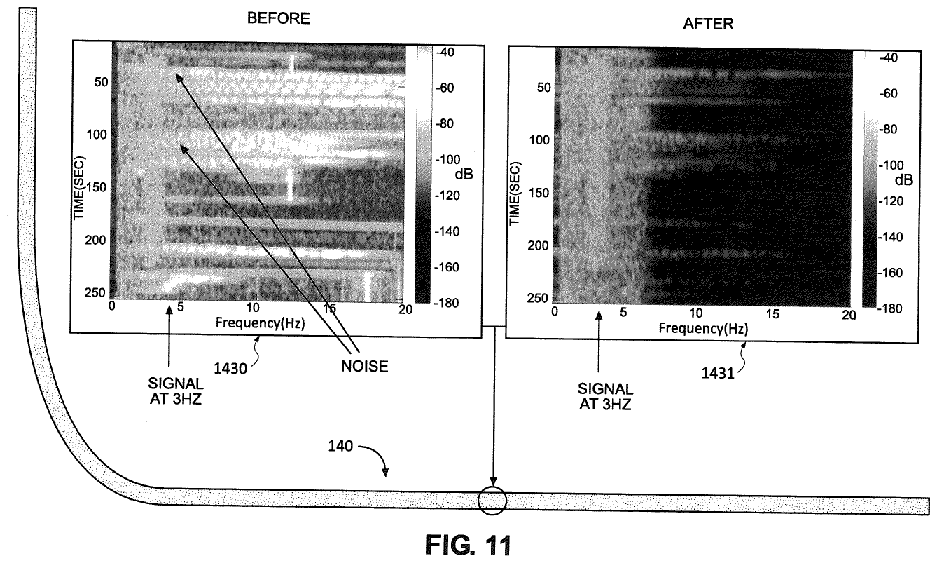

FIG. 11 provides noise cancellation data on EMT signals 135 acquired on a drilling rig 10 during drilling operations. The EMT data was acquired when the transmitter 120 was over 4,000 feet into the lateral 140 of the wellbore 15 at the approximate relative location shown in FIG. 11. The total vertical depth was nearly 10,000 feet. The sensor deployment was similar to that shown schematically in FIG. 7 where a capacitive electrode-based individual sensor was located near 1201, a second capacitive electrode-based individual sensor was located near 1210. The signal voltage output from individual sensors were measured with respect to galvanic electrode individual sensors located within 100 feet of each individual sensor. The transmitter 120 was operating at a frequency of near 3 Hz and this desired signal can be seen in the spectrograms that plot frequency vs time for the EMT signal before and after adaptive noise cancellation. A large amount of noise interference can be seen in the “before” noise cancellation spectrogram 1430. Bandpass filtering (low cutoff at 1 Hz and high cutoff at 6 Hz) was used prior to the adaptive noise cancellation. A large cancellation of the noise can be seen in the “after” noise cancellation spectrogram 1431. The adaptive noise cancellation enables substantial cancellation of noise interference near the frequency of the desired telemetry signal. This noise interference mostly stems from large motors turning on and off. An average reduction in signal to noise of 5× was achieved with a peak reduction in signal to noise of 44×. Noise cancellation was also demonstrated (not shown) with an individual sensor located near individual sensor 1212 instead of near individual sensor 1210. Note that all individual sensors where noise cancellation was demonstrated were located on the same side of the wellbore as the lateral and within an angle of 90 degrees from each other as measured in the plane of the surface of the earth with respect to the wellbore. If individual sensor 1201 near the lateral is considered at 0 degrees, then individual sensor 1212 would be just under 90 degrees away.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. Changes may be made in details, particularly in matters of shape, size, and arrangement of parts without exceeding the scope of the disclosure. The disclosure's scope is, of course, defined in the language in which the appended claims are expressed.

1. A system for measuring, at or near the surface of the earth, a telemetry signal generated by a wellbore transmitter in the presence of at least one interfering signal comprising:
a first sensor module including a first electronic circuit and first and second individual sensors, with at least one individual sensor connected to the first electronic circuit unit, said first sensor module located at or near the surface of the earth and configured to measure a first signal encompassing both the telemetry signal generated by the wellbore transmitter and the at least one interfering signal;
a second sensor module including a second electronic circuit and third and fourth individual sensors, with at least one individual sensor connected to the second electronic circuit, said second sensor module located at or near the surface of the earth and configured to measure a second signal encompassing the telemetry signal and the at least one interfering signal; and
a signal processing unit connected to the first and second sensor modules for executing signal processing techniques on the first and second signals to develop an estimate of the at least one interfering signal and to obtain the telemetry signal.

2. The system of claim 1 wherein the signal processing unit is further configured to determine the estimate of the at least one interfering signal at the first sensor module and to use the estimate to reduce the at least one interfering signal from the first signal to obtain the telemetry signal.

3. The system of claim 1, wherein one of the sensor modules measures the at least one interfering signal, enabling this sensor module to be used as a noise reference channel and the signal processing techniques include adaptive noise cancellation using the noise reference channel.

4. The system of claim 1, wherein the signal processing techniques include adaptive noise cancellation using outputs of at least two sensor modules that are combined to produce a synthetic signal channel input for the adaptive noise cancellation.

5. The system of claim 1, wherein outputs from at least two of the individual sensors are combined to produce at least one noise reference channel and the signal processing techniques include adaptive noise cancellation using the at least one noise reference channel and
wherein the signal processing techniques include adaptive noise cancellation using outputs of the at least two noise reference channels combined to produce a synthetic noise reference channel input for the adaptive noise cancellation along with a third sensor module used as signal channel input for the adaptive noise cancellation and:
wherein the signal processing techniques include adaptive noise cancellation using at least two noise reference channels added or subtracted together to produce a synthetic noise reference channel having a reduced amount of the telemetry signal for the adaptive noise cancellation or
wherein the signal processing techniques include adaptive noise cancellation using the outputs of at least two signal sensor modules combined to produce a synthetic signal channel input for the adaptive noise cancellation.

6-8. (canceled)

9. The system of claim 1, wherein the signal processing unit is further configured to calculate a mutually uncorrelated set of signals and to determine the estimated interfering signal from the mutually uncorrelated set of signals and determine an estimated sensitivity of each sensor module to the telemetry signal and to the at least one interfering signal based on the mutually uncorrelated set of signals and to determine the estimate of the at least one interfering signal based on the estimated sensitivity and the signal processing unit is further configured to update the estimated sensitivity over time.

10-11. (canceled)

12. The system of claim 1, wherein the signal processing techniques include one or more of convolutional neural networks, machine learning, artificial intelligence, principal component analysis, independent component analysis, single value decomposition, or adaptive noise cancellation, either used alone or in combination.

13. (canceled)

14. The system of claim 1, wherein at least one of the individual sensors is a capacitive electrode and connected to an electronic circuit and wherein an electromagnetic field signal of interest generated by a wellbore transmitter located within an MWD and/or LWD unit is measured to aid in geosteering the drill.

15. (canceled)

16. A method for measuring, at or near the surface of the earth, a telemetry signal generated by a wellbore transmitter in the presence of at least one interfering signal comprising:
measuring, at or near the surface of the earth, a first signal encompassing both the telemetry signal generated by the wellbore transmitter and at least one interfering signal with a first sensor module including a first electronic circuit and first and second individual sensors, with at least one individual sensor connected to the first electronic circuit unit;
measuring, at or near the surface of the earth, a second signal encompassing the telemetry signal and the at least one interfering signal with a second sensor module including a second electronic circuit and third and fourth individual sensors, with at least one individual sensor connected to the second electronic circuit; and
executing signal processing techniques, with a signal processing unit on the first and second signals to develop an estimate of the at least one interfering signal and to obtain the telemetry signal.

17. The method of claim 16, wherein executing signal processing techniques further comprises determining the estimate of the at least one interfering signal at the first sensor module and using the estimate to reduce the at least one interfering signal from the first signal to obtain the telemetry signal,
wherein one of the sensor modules measures the at least one interfering signal enabling this sensor module to be used as a noise reference channel and executing signal processing techniques further comprises executing adaptive noise cancellation using the noise reference channel, or
wherein executing signal processing techniques further comprises obtaining outputs of at least two of the sensor modules, combining the outputs to produce a synthetic signal channel input for the adaptive noise cancellation.

18-19. (canceled)

20. The method of claim 16, wherein at least two of the individual sensors are combined to produce at least two noise reference channels and executing signal processing techniques further comprises executing adaptive noise cancellation using the at least two noise reference channels and:
wherein the signal processing techniques include adaptive noise cancellation using outputs of the at least two noise reference channels combined to produce a synthetic noise reference channel for the adaptive noise cancellation along with a third sensor module used as a signal channel input for the adaptive noise cancellation or
wherein the signal processing techniques include adaptive noise cancellation using the outputs of the at least two noise reference channels added or subtracted together to produce a synthetic noise reference channel having a reduced amount of the telemetry signal for the adaptive noise cancellation or
wherein executing signal processing techniques further comprises obtaining outputs of at least two sensor modules, combining the outputs to produce a synthetic signal channel input for the adaptive noise cancellation.

21-23. (canceled)

24. The method of claim 16, wherein the signal processing techniques include calculating a mutually uncorrelated set of signals and determining the estimated interfering signal from the mutually uncorrelated set of signals and wherein the signal processing techniques include determining an estimated sensitivity of each sensor module to the telemetry signal and to the at least one interfering signal based on the mutually uncorrelated set of signals and determining the estimate of the at least one interfering signal based on the estimated sensitivity and wherein the signal processing techniques further include updating the estimated sensitivity over time.

25-26. (canceled)

27. The method of claim 16, wherein the signal processing techniques include one or more of convolutional neural networks, machine learning, artificial intelligence, principal component analysis, independent component analysis, single value decomposition, or adaptive noise cancellation, either used alone or in combination with one or more of the others.

28. (canceled)

29. The method of claim 16, wherein at least one of the individual sensors is a capacitive electrode and connected to an electronic circuit or wherein an electromagnetic field signal of interest is measured to aid in geosteering the drill.

30. (canceled)

31. The method of claim 16 further comprising:
measuring, at or near the surface of the earth, a third signal encompassing the telemetry signal and the at least one interfering signal with a third sensor module including a third electronic circuit and fifth and sixth individual sensors, with at least one individual sensor connected to the third electronic circuit; and
executing signal processing techniques, with a signal processing unit on the first, second and third signals to develop an estimate of the at least one interfering signal and to obtain the telemetry signal.

32. The method of claim 31, wherein executing signal processing techniques further comprises:
determining the estimate of the at least one interfering signal at the first sensor module and using the estimate to reduce the at least one interfering signal from the first signal to obtain the telemetry signal,
measuring the at least one interfering signal with a sensor module to obtain a noise reference channel and executing signal processing techniques includes executing adaptive noise cancellation based on the noise reference channel, or
obtaining outputs of at least two of the sensor modules and combining the outputs to produce a synthetic signal channel input for the adaptive noise cancellation.

33-34. (canceled)

35. The method of claim 31, wherein outputs of at least two of the individual sensors are combined to produce at least one noise reference channel and executing signal processing techniques further comprises executing adaptive noise cancellation based on the noise reference channel and:
wherein the signal processing techniques include adaptive noise cancellation using outputs of the at least two noise reference channels combined to produce a synthetic noise reference input for the adaptive noise cancellation along with an output of a third sensor module used as the signal channel input for the adaptive noise cancellation or
wherein the signal processing techniques include adaptive noise cancellation using the outputs of the at least two noise reference channels added or subtracted together to produce a synthetic noise reference channel having a reduced amount of the telemetry signal and being the noise reference channel input for the adaptive noise cancellation or
wherein executing signal processing techniques further comprises obtaining outputs of at least of the two sensors modules, combining the outputs to produce a synthetic signal channel having a synthetic output and employing the synthetic output as a signal channel input for the adaptive noise cancellation.

36-38. (canceled)

39. The method of claim 31, wherein executing the signal processing techniques include calculating a mutually uncorrelated set of signals and to determine the estimated interfering signal from the mutually uncorrelated set of signals and wherein executing the signal processing techniques include determining an estimated sensitivity of each sensor module to the telemetry signal and to the at least one interfering signal based on the mutually uncorrelated set of signals and determining the estimate of the at least one interfering signal based on the estimated sensitivity and wherein executing the signal processing techniques further include updating the estimated sensitivity over time.

40-41. (canceled)

42. The method of claim 31, wherein the signal processing techniques include one or more of convolutional neural networks, machine learning, artificial intelligence, principal component analysis, independent component analysis, single value decomposition, or adaptive noise cancellation, either used alone or in combination with one or more of the others.

43. (canceled)

44. The method of claim 31, wherein at least one of the individual sensors is a capacitive electrode and connected to an electronic circuit, or wherein an electromagnetic field signal of interest is measured to aid in geosteering the drill.

45. (canceled)

46. A method for measuring, at or near the surface of the earth, a telemetry signal generated by a wellbore transmitter in the presence of at least one interfering signal comprising:
measuring a first signal representing the desired signal and the at least one interfering signal with a first individual sensor and a second individual sensor;
measuring a second signal representing the desired signal and the at least one interfering signal with a third individual sensor and either a fourth individual sensor or at least one of the first and second individual sensors;
wherein at least one of the individual sensors is a capacitive electrode connected to an electronic circuit; and
executing signal processing techniques with a signal processing unit, on the first and second signals to develop an estimate of the at least one interfering signal and to obtain the telemetry signal.

47. The method according to claim 46,
wherein the signal processing techniques include adaptive noise cancellation and principal component analysis, independent component analysis or singular value decomposition;
wherein outputs from at least two of the individual sensors are combined to produce at least one noise reference channel and executing signal processing techniques further comprises executing adaptive noise cancellation using the at least one noise reference channel or
wherein at least two of the individual sensors are configured in a gradiometer arrangement and wherein the signal processing techniques include one or more of adaptive noise cancellation, principal component analysis, independent component analysis or singular value decomposition and
further comprising measuring a third signal, representing the desired signal and the at least one interfering signal, with the at least two individual sensors.

48-50. (canceled)

51. The method according to claim 50, wherein executing signal processing techniques further comprises combining the outputs of at least two of the signals to produce a synthetic signal channel employed as an input for the adaptive noise cancellation, or wherein the signal processing techniques include adaptive noise cancellation combining at least two signals to produce a synthetic noise reference channel having a reduced amount of the telemetry signal and employed as the noise reference channel input for the adaptive noise cancellation.

52. (canceled)

53. The method according to claim 46, wherein at least one individual sensor configured to measure the desired signal and interfering signals and at least one additional individual sensor configured to measure interfering noise are located on the same side of the wellbore as the lateral and within an angle of 90 degrees from each other as measured in the plane of the surface of the earth with respect to the wellbore.

54. A system for measuring, at or near the surface of the earth, a desired signal generated by a wellbore transmitter in the presence of at least one interfering signal comprising:
a first individual sensor and a second individual sensor configured to measure the desired signal and the at least one interfering signal;
a third individual sensor and either a fourth individual sensor or at least one of the first and second individual sensors collectively configured to measure a second signal representing the desired signal and the at least one interfering signal;
wherein at least one of the individual sensors is a capacitive electrode connected to an electronic circuit; and
a signal processing unit configured to execute signal processing techniques on the first and second signals to develop an estimate of the at least one interfering signal and to obtain the desired signal.

55. The system according to claim 54,
wherein the signal processing techniques include adaptive noise cancellation, principal component analysis, independent component analysis or singular value decomposition,
wherein the output of at least two of the individual sensors are combined to produce at least one noise reference channel and the signal processing unit is further configured to execute adaptive noise cancellation using the at least one noise reference channel,
wherein at least two of the individual sensors are configured in a gradiometer arrangement and wherein the signal processing techniques include adaptive noise cancellation and/or principal component analysis, independent component analysis or singular value decomposition,
wherein at least two individual sensors are configured to measure a third signal representing the desired signal and the at least one interfering signal,
wherein the signal processing unit is further configured to obtain outputs of at least two signals, and to combine the outputs to produce a synthetic signal channel employed as a signal channel input for adaptive noise cancellation, or
wherein the signal processing unit is further configured to obtain outputs of at least two signals, and to combine the outputs to produce a synthetic noise reference channel employed as a noise reference channel input for adaptive noise cancellation.

56-60. (canceled)

61. The system of claim 54, further comprising:
a signal processing unit that uses analog signal processing and a microcontroller with digital signal processors to execute signal processing techniques including adaptive noise cancellation, principle principal component analysis, independent component analysis or single value decomposition, either individually or in combination, and
a wireless transceiver for communication between the sensor and the signal processing unit, or between different sensors, or between different sensors and the signal processing unit, or
a signal decoding unit.

62-63. (canceled)
